(19) United States
(12) Patent Application Publication
(10) Pub. No.: US 2007/0299177 A1
(43) Pub. Date: Dec. 27, 2007

(54) AQUEOUS DURABLE HYDROPHILIC WASHING AND COATING COMPOSITIONS

(76) Inventor: Ashot Serobian, Martinez, CA (US)

Correspondence Address: THE CLOROX COMPANY, P.O. BOX 24305, OAKLAND, CA, 94623-1305, US

(21) Appl. No.: 11/426,678

(22) Filed: Jun. 27, 2006

(51) Int. Cl. B60C 1/00

(52) U.S. Cl. 524/261; 524/236; 524/556; 524/493; 524/431; 524/379; 524/386

(57) ABSTRACT

The present invention relates to an aqueous hydrophilic coating composition and method for treating various hard surfaces including, but not limited to, rubber metal, glass, plastic, vinyl, ceramic, stone, or various other painted surfaces to create a hydrophilic surface without visible residue or water spots. The coating composition comprises a hydroxyl functional compound, a silane compound and water. The aqueous hydrophilic coating composition can be used both as a dilute washing solution to clean surfaces and a coating composition to provide a durable protection from future stains and residues. The coating composition can be applied directly or indirectly to a solid surface using various application devices including, but not limited to, spray, aerosol, wipes, towels, sponges and pads.

### FIELD OF THE INVENTION

The present invention relates to an aqueous-based, hydrophilic coating composition and method for adding shine and gloss hard surfaces. The hydrophilic coating composition also inhibits the appearance of water spots by allowing water to sheet off the treated surface and dry as a relatively thin uniform layer rather than beading up in droplets and forming water spots as the droplets dry on the surface. The coating compositions are durable because they can withstand a number of washes with water and still maintain their beneficial hydrophilic nature.

### BACKGROUND OF THE INVENTION

Products for cleaning hard surfaces are widely available on the market. These products are used for two purposes, the first being to clean soil from the surface and the second being to leave the surface with an aesthetically pleasing finish e.g. spot-free or shiny. However products available on the market often require rinsing with water after use. Typically when the water dries from the surface water-marks, smears or spots are left behind. These water-marks, it is believed may be due to the evaporation of water from the surface leaving behind deposits of minerals which were present as dissolved solids in the water, for example calcium, magnesium and sodium ions and salts thereof or may be deposits of water-carried soils, or even remnants from a cleaning product, for example soap scum.

This problem is often exacerbated by some cleaning compositions which modify the surface during the cleaning process in such a way that after rinsing, water forms discrete droplets or beads on the surface instead of draining off. These droplets or beads dry to leave consumer noticeable spots or marks known as water spots. This problem is particularly apparent when cleaning ceramic, steel, plastic, glass or painted surfaces. A means of solving this problem, known in the art is to dry the water from the surface using a cloth or chamois before the water-marks form. However this drying process is time consuming and requires considerable physical effort.

U.S. Pat. No. 5,759,980 assigned to Blue Coral describes a composition for cleaning cars, which is described to eliminate the problem of water-marks. The composition described comprises a surfactant package comprising a silicone-based surfactant and a polymer which is capable of bonding to a surface to make it hydrophilic. However the polymers described in this document are removed from the surface during rinsing of the product from the surface. Hence since the surface hydrophilicity is allegedly provided by the composition as described in the patent and the composition is completely removed from the surface after the first rinse, the alleged hydrophilicity is also removed. The result is that the benefit provided by the composition is lost when the surface is rinsed.

DE-A-21 61 591 also describes a composition for cleaning cars wherein the surface is made hydrophilic by application of animo-group containing copolymers such as polyermic ethyleneimines, polymeric dimethyl aminoethylacrylate or methacrylate or mixed polymerisates. However as with the composition described above the polymers are also rinsed off in the first rinse of the car, thereby removing any benefit the polymers could have provided.

U.S. Pat. No. 6,846,512 assigned to Procter & Gamble describes a composition for cleaning cars that eliminates the problem of water-marks by treating the vehicle surface with a hydrophilic washing composition and then rinsing the surface with purified water. The part of the reason that the Procter & Gamble composition and method is successful at reducing water spots is because the rinse step is being done with purified water, which has filtered out any dissolved solids in the water that can cause water spots. The problem with method is that it is not always possible or practical to wash hard surfaces with purified water. Additionally, with respect to vehicle surfaces it is likely that they will be exposed to rain, frost, snow or other sources of water, which has not been purified and will leave water spots. The Procter & Gamble composition and method does not provide a durable hydrophilic wash and coating composition that can be applied and rinsed with regular tap water without the appearance of water spots.

There exists a strong consumer need for a durable, aqueous washing and coating composition, which create a shiny surface without visible residue and does not show water spots.

### SUMMARY OF THE INVENTION

The present invention relates to an aqueous hydrophilic composition and method for treating various hard surfaces including, but not limited to, rubber, ceramic, stone, acrylic, vinyl, plastic, metal, plastic, glass, and various painted surfaces. The aqueous hydrophilic coating composition has a wide variety of applications outside the home on hard surfaces including, but not limited to, vehicle surfaces, glass, outdoor furniture, and other exterior painted surfaces. In addition the coating composition also has applications within the home on bathroom and kitchen surfaces where hard surface cleaners and protectant composition are frequently used and residue and/or water spots are a problem. The hyrdrophilic coating composition comprises a hydroxyl functional compound, a silane compound and water. The silane compound in the hydrophilic coating composition preferably comprises an amine functional silane. The aqueous, hydrophilic coating composition may be used a washing or cleaning composition as well as a coating and protectant.

The coating composition can be applied directly or indirectly to a hard surface using various application devices including, but not limited to, spray, aerosol, wipes, sponges and pads. The coating composition dries on the treated surface in a uniform layer, which appears shiny, glossy and shows no visible residue either from the coating or the water droplets as it dries. Once the coating composition dries on the surface treated with the composition, the treated surface becomes hydrophilic allowing water to sheet off of the surface without forming droplet marks or streaks. Once the coating composition is applied to a surface, the treated surface will remain hydrophilic for at least 5 washes with water. More preferably the treated surface will remain hydrophilic for at least 10 washes with water. The coating composition is ideal for a variety of surfaces because it leaves no visible residue on the surface, which is treated with the composition, and the composition gives the surface a clean and shiny appearance.

### DETAILED DESCRIPTION OF THE INVENTION

Before describing the present invention in detail, it is to be understood that this invention is not limited to particularly exemplified systems or process parameters as such may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, some of the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone, not accounting for the substrate weight. Each of the noted cleaner composition components and substrates is discussed in detail below.

As used herein, the term “substrate” is intended to include any material that is used to clean or coat an article or a surface. A wide variety of materials can be used as the substrate. Examples of suitable substrates include but are not limited to, nonwoven substrates, woven substrates, foams and sponges. The substrate can be attached to a cleaning implement, such as a window washing tool, a floor mop, a handle, or a hand held cleaning tool, such as a wheel-cleaning device. The substrate may also be used independently as a wipe, pad, sponge, scrubber, etc.

As used herein, “wiping” refers to any shearing action that the substrate undergoes while in contact with a target surface. This includes hand or body motion, substrate-implement motion over a surface, or any perturbation of the substrate via energy sources such as ultrasound, mechanical vibration, electromagnetism, and so forth.

As used herein, the term “treated surface” is intended to include a substrate or surface to which the aqueous, hydrophilic coating composition has previously been applied. Examples of treated surfaces may include, but are not limited to metal, glass, rubber, painted surfaces and any other surfaces which would benefit from enhanced shine and reduction of water spots. By the term ‘surface’ it is meant those surfaces typically found in houses like kitchens and bathrooms, e.g., floors, tiles, windows, sinks, baths, showers, fixtures and fittings made of different materials like ceramic, porcelain, enamel, vinyl, no-wax vinyl, linoleum, melamine, glass, any plastics, plastified wood, metal, especially steel and chrome metal, varnished or sealed surfaces and especially, the exterior surfaces of a vehicle, e.g. painted, plastic or glass surfaces and finishing coats.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic and/or amphoteric agents.

The aqueous hydrophilic composition of the present invention can be used both as washing and cleaning composition and/or as a protective coating composition. The aqueous hydrophilic composition comprises: a hydroxyl functional compound, an amine functional silane and water. In a preferred embodiment of the invention, the hydroxyl functional compound is an alcohol, a diol, a polyol, glycerin, a carboxyl functional polymer, a carboxyl functional copolymer or any combinations thereof. In one embodiment, the hydroxyl functional compound is a vinyl acrylic copolymer such as Alcosperce® 747 or Alcoguard® 4000, which are produced by Alco Chemical. Other suitable hydoxyl functional compounds include, but are not limited to, ethylene glycol and propylene glycol. In the coating composition the amine functional silane and the hydroxyl functional compound work together to create a hydrophilic surface coating that allows water to sheet off the treated surface once the coating composition dries.

The aqueous hydrophilic coating composition may be formulated as a concentrated solution, which is then diluted with water prior to use as a washing and/or coating treatment. For example, the composition may be used as a car washing and coating composition, which is formulated as a concentrate and then diluted about 50% to 99% by water to create a dilute car wash, and coating. The aqueous hydrophilic coating composition may also be formulated as a ready-to-use composition for protective coatings. For example, the coating composition may be used directly out of the bottle as a tire treatment. Given these variations in use and application style the concentrations of the components in the aqueous hydrophilic coating compositions may vary widely depending on whether the composition is a concentrated formulation or a ready-to-use formulation.

A concentrated aqueous hydrophilic coating composition comprises about 6 to 80% by weight of the hydroxyl functional compound; about 4 to 30% by weight of the amine functional silane and the composition is water. The hydroxyl functional compound is preferably about 15 to 40% by weight of the composition and most preferably about 20 to 35% by weight of the composition. In preferred embodiment of the concentrated coating composition, amine functional silane comprises about 5 to 25% by weight of the composition and most preferably about 10 to 20% by weight of the composition. In another embodiment of the invention, the hydrophilic coating composition may further comprise an alkyl functional silane and a phenyl functional silane. In a preferred embodiment of the invention the alkyl functional silane comprises about 1 to 20% by weight of the composition and more preferably about 1 to 5% by weight of the composition. In a preferred embodiment of the invention the phenyl functional silane comprises about 0.01 to 10% of the composition by weight and more preferably about 0.02 to 1% by weight of the composition.

### Hydroxyl Functional Compounds

The hydroxyl functional compounds are used in the composition to create a uniform distribution and leveling of the coating on a treated surface. Suitable hydroxyl functional compounds include but are not limited to, alcohols, diols, polyols, carboxyl functional polymers, and carboxyl functional copolymers. In a preferred embodiment of the invention the hydroxyl functional compound is a polyol and most preferably the hydroxyl functional is a monomeric polyol such as glycerin. Polymeric polyols may be polyethers such as polyethylene glycol, polypropylene glycol, or polytetrahydrofuran. Another class of polymeric polyols is the polyesters. A specialist class of polyol is the hydroxyl-terminated polybutadienes which are extensively used in formulations for polyurethanes. Monomeric polyols, include but are not limited to, pentaerythritol and glycerin.

In another embodiment of the invention the hydroxyl functional compound comprises carboxyl functional polymers or carboxyl functional copolymers. The carboxyl functional polymer or carboxyl functional compolymers are preferably acryl functional polymer or compolymers and most preferably vinyl acrylic polymer or copolymer. A suitable examples of a vinyl acrylic copolymers are made by Alco Chemical and sold under the name Alcosperce® Polymers, including Alcosperse® 747. In a preferred embodiment of the invention, the hydroxyl functional compound comprises a vinyl acrylic copolymer and glycerin. In another embodiment of the invention, the ratio of the hydroxyl functional compound to amine functional silane is about 1:1 to about 4:1 and more preferably about 1:1 to about 1:2.

### Amine Functional Silanes

Matching the organofunctional group with the silane determines the properties of the organosilane and the types of applications where it should be used. In this case the amine functional group of the organosilane means that it is hydrophilic which enables the coating composition to create a hydrophilic surface once the coating dries on a treated surface. Suitable examples of a vinyl acrylic copolymers are made by Dow Corning and sold under the name Dow Corning® brand Silane, including but not limited to, DC Silane® Z-6020, DC Silane® Z-6011, DC Silane® Z-6020, DC Silane® Z-6137, DC Silane® Z-6028, DC Silane® Z-6032 and DC Silane® Z-6224.

### Alkyl Functional Silanes

In one embodiment of the hydrophilic coating composition an alkyl functional silane is added to the composition to improve the drying time of the coating on a treated surface. Suitable alkyl functional silanes include but are not limited to, methyltrimethoxysilane, dimethyldimethoxysilane, proplytrimethoxysilane, isobutyltrimethoxysilane, and combinations thereof. In a preferred embodiment of the invention, the alkyl functional silane is a methyl functional silane. Examples of a methyl functional silanes are made by Dow Corning and sold under the name Dow Corning® brand Silane, including but not limited to, DC Silane® Z-6070, DC Silane® Z-6366, DC Silane® Z-6370, DC Silane® Z-6383, DC Silane® Z-6194, DC Silane® Z-6265, DC Silane® Z-6535, DC Silane® Z-2306, and DC Silane® Z-6403.

### Phenyl Functional Silanes

In one embodiment of the hydrophilic coating composition a phenyl functional silane is added to the composition to improve the drying time of the coating on a treated surface and the thermal stability of the composition. Suitable phenyl functional silanes include but are not limited to, phenyltrimethoxysilane. In a preferred embodiment of the invention, the alkyl functional silane is a methyl functional silane. Examples of a methyl functional silanes are made by Dow Corning and sold under the name Dow Corning® brand Silane, including but not limited to, DC Silane® Z-6070, DC Silane® Z-6366, DC Silane® Z-6370, DC Silane® Z-6383, DC Silane® Z-6194, DC Silane® Z-6265, DC Silane® Z-6535, DC Silane® Z-2306, and DC Silane® Z-6403.

The aqueous hydrophilic coating composition may additionally contain optional adjuncts, including but not limited to, solvents, surfactants, fragrances or perfumes, pH adjusting agents, stabilizers, thickeners, defoamers, swellable polymers, preservatives, propellants, buffers, dyes, and UV stabilizers.

The washing and coating composition may be applied to a surface by any practical means, including but not limited to, wipes, pads, sponge, soaking, spraying and coating. In one embodiment of the invention, the coating composition is a concentrated washing composition that is diluted with water prior to use. The concentrated coating composition may be used in applications including for washing automobiles, boats, or other vehicles. In another embodiment of the invention the composition is in a dilute form and is used in a trigger or an aerosol spray to provide protection and shine to a treated surface. The dilute spray application of the coating composition maybe used in auto or vehicle detailing applications or for treatment of outside furniture or bathroom and kitchen surfaces such as tubs and showers, tile, sinks, etc. In a further embodiment of the invention, the coating composition may be applied using a sponge, pad or any other suitable applicator to treat vehicle tires and provide protection and shine.

Once the coating composition has been applied to the surface of an article it may be allowed to dry by letting the water evaporate or may be manually dried by any suitable means. Once the coating composition is dry on a surface, it forms a resulting protective coating on the surface, which creates a clean and shiny appearance. The coating composition creates a hydrophilic surface on the treated object, which allows water or other liquids to sheet off the surface. Since fluids sheet off the treated surface rapidly, water spots and visible residues do not form on the treated surface even on surfaces that dry rapidly. For example, many car washes and window cleaner leave residues or water spots on a surface if they are not wiped clean and/or dried off. Residues and water spots are a particular problem with car washes and window cleaners in high temperatures because surfaces tend to dry more quickly before they can be rinsed off or wiped dry. The coating composition of the present invention addresses this problem of water spots and residues by creating hydrophilic surfaces that makes fluids sheet off the surface that prevents residues from forming eliminating the need to wipe clean or dry off the treated surfaces.

The system and method for applying the coating composition to a surface involves, applying the composition to a surface allowing the treated surface to dry. Once the protectant composition is applied to a substrate surface, the treated surface becomes hydrophilic causing staining fluids to sheet off of the treated substrate surface. An absorbent article may be used to wipe or pat dry any remaining fluids on the treated surface that have not evaporated or sheeted off the surface. The absorbent article may be a wide variety of materials including but not limited to sponges, towels, paper materials, tissues, and any other suitable materials.

### Additional Adjuncts

The cleaning compositions optionally contain one or more of the following adjuncts: stain and soil repellants, lubricants, odor control agents, perfumes, fragrances and fragrance release agents. Other adjuncts include, but are not limited to, builders and pH adjusting agents, dispersing agents, electrolytes, dyes and/or colorants, solubilizing materials, stabilizers, thickeners, defoamers, hydrotropes, surfactants, cloud point modifiers, preservatives, and other polymers.

Suitable surfactants, when used, include, anionic, nonionic and amphoteric surfactants and combinations thereof. In a preferred embodiment of the invention, the surfactants are low residue surfactants. Examples of suitable surfactants include, but are not limited to, alkyl polyglocosides (APGs), sulfate surfactants, Alkyl Sulpohonate surfactants, ethoxylated alcohols, hydroxysultaine surfactants and any combinations thereof. Examples of suitable surfactants include, APG325N and Standapol WAQ-LCX produced by Congis. Other suitable surfactants include, Hotapur SAS 30 and Genapol UD-070 produced by Clariant Corporation. Additional surfactants include surfactants produced by Stepan such as Amphosol CS-50.

The solubilizing materials, when used, include, but are not limited to, hydrotropes (e.g. water soluble salts of low molecular weight organic acids such as the sodium and/or potassium salts of toluene, cumene, and xylene sulfonic acid). The acids, when used, include, but are not limited to, organic hydroxy acids, citric acids, keto acid, and the like. Electrolytes, when used, include, calcium, sodium and potassium chloride. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/hydrocarbon blends.

Preservatives, when used, include, but are not limited to, mildewstat or bacteriostat, methyl, ethyl and propyl parabens, short chain organic acids (e.g. acetic, lactic and/or glycolic acids), bisguanidine compounds (e.g. Dantagard and/or Glydant) and/or short chain alcohols (e.g. ethanol and/or IPA). The mildewstat or bacteriostat includes, but is not limited to, mildewstats (including non-isothiazolone compounds) include Kathon GC, a 5-chloro-2-methyl-4-isothiazolin-3-one, KATHON ICP, a 2-methyl-4-isothiazolin-3-one, and a blend thereof, and KATHON 886, a 5-chloro-2-methyl-4-isothiazolin-3-one, all available from Rohm and Haas Company; BRONOPOL, a 2-bromo-2-nitropropane 1, 3 diol, from Boots Company Ltd., PROXEL CRL, a propyl-p-hydroxybenzoate, from ICI PLC; NIPASOL M, an o-phenyl-phenol, Na+salt, from Nipa Laboratories Ltd., DOWICIDE A, a 1,2-Benzoisothiazolin-3-one, from Dow Chemical Co., and IRGASAN DP 200, a 2,4,4′-trichloro-2-hydroxydiphenylether, from Ciba-Geigy A.G.

The composition may include a builder or buffer, which increase the effectiveness of the surfactant. The builder or buffer can also function as a softener and/or a sequestering agent in the cleaning composition. A variety of builders or buffers can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Builders or buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These builders or buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are tri(hydroxymethyl)amino methane (TRIS), 2-amino-2-ethyl-1,3-propanediol, 2-amino-2-methyl-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. For additional buffers see WO 95/07971, which is incorporated herein by reference. Other preferred pH-adjusting agents include sodium or potassium hydroxide.

### Nanoparticles

Nanoparticles, defined as particles with diameters of about 400 nm or less, are technologically significant, since they are utilized to fabricate structures, coatings, and devices that have novel and useful properties due to the very small dimensions of their particulate constituents. “Non-photoactive” nanoparticles do not use UV or visible light to produce the desired effects. Nanoparticles can have many different particle shapes. Shapes of nanoparticles can include, but are not limited to spherical, parallelpiped-shaped, tube shaped, and disc or plate shaped. Nanoparticles with particle sizes ranging from about 2 nm to about 400 nm can be economically produced. Particle size distributions of the nanoparticles may fall anywhere within the range from about 1 nm, or less, to less than about 400 nm, alternatively from about 2 nm to less than about 100 nm, and alternatively from about 2 nm to less than about 50 nm. For example, a layer synthetic silicate can have a mean particle size of about 25 nanometers while its particle size distribution can generally vary between about 10 nm to about 40 nm. Alternatively, nanoparticles can also include crystalline or amorphous particles with a particle size from about 1, or less, to about 100 nanometers, alternatively from about 2 to about 50 nanometers. Nanotubes can include structures up to 1 centimeter long, alternatively with a particle size from about 1 nanometer, or less, to about 50 nanometers. Nanoparticles can be present from 0.01 to 1%.

Inorganic nanoparticles generally exist as oxides, silicates, carbonates and hydroxides. These nanoparticles are generally hydrophilic. Some layered clay minerals and inorganic metal oxides can be examples of nanoparticles. The layered clay minerals suitable for use in the coating composition include those in the geological classes of the smectites, the kaolins, the illites, the chlorites, the attapulgites and the mixed layer clays. Smectites include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Illites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications.

The layered clay minerals suitable for use in the coating composition may be either naturally occurring or synthetic. An example of one embodiment of the coating composition uses natural or synthetic hectorites, montmorillonites and bentonites. Another embodiment uses the hectorites clays commercially available. Typical sources of commercial hectorites are LAPONITE® from Southern Clay Products, Inc., U.S.A; Veegum Pro and Veegum F from R. T. Vanderbilt, U.S.A.; and the Barasyms, Macaloids and Propaloids from Baroid Division, National Read Comp., U.S.A.

The inorganic metal oxides used in the coating composition may be silica- or alumina-based nanoparticles that are naturally occurring or synthetic. Aluminum can be found in many naturally occurring sources, such as kaolinite and bauxite. The naturally occurring sources of alumina are processed by the Hall process or the Bayer process to yield the desired alumina type required. Various forms of alumina are commercially available in the form of Gibbsite, Diaspore, and Boehmite from manufacturers such as Condea.

Synthetic hectorites, such as LAPONITE RD®, do not contain any fluorine. An isomorphous substitution of the hydroxyl group with fluorine will produce synthetic clays referred to as sodium magnesium lithium fluorosilicates. These sodium magnesium lithium fluorosilicates, marketed as LAPONITE B® and LAPONITE S®, contain fluoride ions of greater than 0% up to about 8%, and preferably about 6% by weight. LAPONITE B® particles are flat disc-shaped, or plate shaped, and have a mean particle size of about 40 nanometers in diameter and about 1 nanometer in thickness. Another variant, called LAPONITE S®, contains about 6% of tetrasodium polyphosphate as an additive. In some instances, LAPONITE B® by itself is believed, without wishing to be bound to any particular theory, to be capable of providing a more uniform coating (that is, more continuous, i.e., less openings in the way the coating forms after drying), and can provide a more substantive (or durable) coating than some of the other grades of LAPONITE® by themselves (such as LAPONITE RD®).

The aspect ratio for disk shaped nanoparticles is the ratio of the diameter of the clay particle to that of the thickness of the clay particle. The aspect ratio of individual particles of LAPONITE® B is approximately 40 and the aspect ratio of individual particles of LAPONITE® RD is approximately 25. A high aspect ratio is desirable for film formation of nanosized clay materials. More important to the invention is the aspect ratio of the dispersed particles in a suitable carrier medium, such as water. The aspect ratio of the particles in a dispersed medium can be considered to be lower where several of the disc shaped particles are stacked on top of one another than in the case of individual particles. The aspect ratio of dispersions can be adequately characterized by TEM (transmission electron microscopy).

LAPONITE B® occurs in dispersions as essentially single clay particles or stacks of two or fewer clay particles. The LAPONITE RD® occurs essentially as stacks of two or more single clay particles. Thus, the aspect ratio of the particles dispersed in the carrier medium can be dramatically different from the aspect ratio of single disc-shaped particle. The aspect ratio of LAPONITE B® is about 20-40 and the aspect ratio of LAPONITE RD® is less than 15.

In some preferred embodiments, the nanoparticles will have a net excess charge on one of their dimensions. For instance, flat plate-shaped nanoparticles may have a positive charge on their flat surfaces, and a negative charge on their edges. Alternatively, such flat plate-shaped nanoparticles may have a negative charge on their flat surfaces and a positive charge on their edges. Preferably, the nanoparticles have an overall net negative charge. This is believed to aid in hydroplilizing the surface coated with the nanoparticles. The amount of charge, or “charge density”, on the nanoparticles can be measured in terms of the mole ratio of magnesium oxide to lithium oxide in the nanoparticles. In preferred embodiments, the nanoparticles have a mole ratio of magnesium oxide to lithium oxide of less than or equal to about 11%.

Depending upon the application, the use of variants and isomorphous substitutions of LAPONITE® provides great flexibility in engineering the desired properties of the coating composition used in the present invention. The individual platelets of LAPONITE® are negatively charged on their faces and possess a high concentration of surface bound water. When applied to a hard surface, the hard surface is hydrophilically modified and exhibits surprising and significantly improved wetting and sheeting, quick drying, uniform drying, anti-spotting, anti-soil deposition, cleaner appearance, enhanced gloss, enhanced color, minor surface defect repair, improved smoothness, anti-hazing properties, modification of surface friction, reduced damage to abrasion and improved transparency properties. In addition, the LAPONITE® modified surface exhibits “self-cleaning” properties (dirt removal via water rinsing, e.g. from rainwater) and/or soil release benefits (top layers are strippable via mild mechanical action).

In contrast to hydrophilic modification with organic polymers, the benefits provided by nanoparticles, such as LAPONITE®, either alone or in combination with a charged modifier, are longer lived. For example, sheeting/anti-spotting benefits are maintained on an automobile body and glass window after multiple rinses versus the duration of such benefits after only about one rinse with tap water or rainwater on a surface coated with hydrophilic polymer technology.

### EXPERIMENTAL

Several specific, non-limiting, examples of the coating composition in weight percent are as follows. The Examples 1 to 3 are coating compositions, which may be prepared as a concentrate or as a dilute washing solution. The Example 4 composition was prepared as ready to use tire treatment formulation. The example compositions, described below, are intended to illustrate the sample compositions that are suitable compositions based on the present invention. As detailed above, the example formulas below can contain other optional adjuncts, and the protectant compositions may be applied to a surface by any suitable means including but not limited to, a pad, sponge, spray, aerosol, washing tools, and any other suitable means.

### Rinse Test Method

For each of the Car Wash Formulas, Examples 1 to 3, a painted automotive panel was washed with a sponge with the dilute version of the formula and washed off using the rinse test method. The rinse test method used according to the present invention consists of spraying the surface with water having 24 French degree hardness using a water delivery device, for example a conventional garden hose or a shower head at a distance from the surface of 1.0 meters for 30 seconds. The flow rate of the water from the water delivery system is approximately 10 liters per minute. Each of the Car Wash Formulas maintained a hydrophilic surface for at least 10 washes using the rinse test method described above. Even at a more dilute concentration or on a slick surface that has been treated with a wax or other surface treatment, the Car Wash Formulas should maintain a hydrophilic surface for at least 5 washes using the rinse test method.

### Example 1

| | | |
|---|---|---|
| Ingredient Detail | Weight Percentage | Acceptable Ranges |

Car Wash Concentrate Formula

| | | |
|---|---|---|
| Alcosperse ® 747 | 33.0% | 6.0–55.0% |
| (by Alco Chemical) | | |
| (styrene acrylic copolymer) | | |
| DC Silane Z-6020 ® | 16.5% | 4.0–30.0% |
| (by Dow Corning) | | |
| (amine functional silane) | | |
| DI Water | Balance | Balance |

Dilute Car Wash Solution

| | | |
|---|---|---|
| Example 1 Concentrate | 0.99% | 0.2–2.0% |
| Formula | | |
| Water | Balance | Balance |

### Example 2

| | | |
|---|---|---|
| Ingredient Detail | Weight Percentage | Acceptable Ranges |

Car Wash Concentrate Formula

| | | |
|---|---|---|
| Alcosperse ® 747 | 33.0% | 6.0–55.0% |
| (by Alco Chemical) | | |
| (styrene acrylic copolymer) | | |
| DC Silane Z-6137 ®* | 69.0% | 15.0–80.0% |
| (by Dow Corning) | | |
| (amine functional silane) | | |
| DI Water | Balance | Balance |

Dilute Car Wash Solution

| | | |
|---|---|---|
| Example 2 Concentrate | 0.99% | 0.2–2.0% |
| Formula | | |
| Water | Balance | Balance |

*DC Silane Z-6137 ® is 24% aqueous solution of DC SilaneZ-6020 ®

### Example 3

| | | |
|---|---|---|
| Ingredient Detail | Weight Percentage | Acceptable Ranges |

Car Wash Concentrate Formula

| | | |
|---|---|---|
| Alcosperse ® 747 | 7.50% | 3.0–15.0% |
| (by Alco Chemical) | | |
| (styrene acrylic copolymer) | | |
| DC Silane Z-6020 ® | 15.0% | 4.0–30.0% |
| (by Dow Corning) | | |
| (amine functional silane) | | |
| Glycerin | 27.50% | 15.0–80.0% |
| DI Water | Balance | Balance |

Dilute Car Wash Solution

| | | |
|---|---|---|
| Example 3 Concentrate | 2.06% | 0.2–5.0% |
| Formula | | |
| Water | Balance | Balance |

### Example 4

Tire Treatment Formula

| Ingredient Detail | Weight Percentage | Acceptable Ranges |
|---|---|---|
| Glycerin | 13.43% | 8.0–16.0% |
| DC Silane Z-6020 ® | 11.15% | 8.0–17.0% |
| (by Dow Corning) | | |
| (amine functional silane) | | |
| DC Silane Z-6070 ® | 3.67% | 0.1–5.0% |
| (by Dow Corning) | | |
| (methyl functional silane) | | |
| DC Silane Z-6124 ® | 0.50% | 0.1–2.0% |
| (by Dow Corning) | | |
| (phenyl functional silane) | | |
| Dowanol PnB ® | 3.0% | 1.0–5.0% |
| (by Dow Chemical) | | |
| (a glycol ether compound) | | |
| DI Water | Balance | Balance |

The foregoing description of illustrated embodiments of the present invention, including what is described in the abstract, is not intended to be exhaustive or to limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

The foregoing description of illustrated embodiments of the present invention, including what is described in the abstract, is not intended to be exhaustive or to limit the invention to the precise forms disclosed herein. While specific embodiments and examples of the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without the corresponding use of other features, without departing from the scope and spirit of the invention as set forth. Therefore, many modifications may be made to adapt a particular situation or material to the essential scope and spirit of the present invention. It is intended that the invention not be limited to the particular terms used in the following claims and/or to the particular embodiment disclosed as the best mode contemplated for carrying out this invention, but that the invention includes any and all embodiments and equivalents falling within the scope of the appended claims.

While various patents have been incorporated herein by reference in the background, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

What is claimed is:

1. A concentrated, hydrophilic, hard surface coating composition comprising:
(a) 6 to 80% by weight of a hydroxyl functional compound selected from the group consisting of: an alcohol, a diol, a polyol, glycerin, a carboxyl functional polymer, a carboxyl functional copolymer and any combinations thereof;
(b) 4 to 30% by weight of an amine functional silane;
(c) the balance is water; and
wherein the ratio of the hydroxyl functional compound to amine functional silane is about 1:1 to about 4:1.

2. The coating composition of claim 1 wherein the pH of the coating composition is about 9 to 11.

3. The coating composition of claim 1 wherein the coating composition can be diluted with water to form a dilute coating composition with at least 90% by weight water.

4. The coating composition of claim 1 wherein the composition creates a hydrophilic coating on the surface being treated and the coating remains hydrophilic for at least 5 rinses with water.

5. The coating composition of claim 1 wherein the composition further comprises an about 0.1 to 5% by weight of an alkyl functional silane.

6. The coating composition of claim 1 wherein the composition further comprises a about 0.1 to 2% by weight of a phenyl functional silane.

7. The coating composition of claim 1 wherein the composition further comprises a nonionic surfactant.

8. A concentrated, hydrophilic, hard surface coating composition comprising:
(a) 6 to 80% by weight of an hydroxyl functional compound selected from the group consisting of: an alcohol, a diol, a polyol, glycerin and any combinations thereof;
(b) 4 to 80% by weight of a silane compound selected from the group consisting of: an amine functional silane, an alkyl functional silane, a phenyl functional silane; and combinations thereof, and
(c) the balance water.

9. The coating composition of claim 8 wherein the pH of the coating composition is about 9 to 11.

10. The coating composition of claim 8 wherein the coating composition further comprises a glycol ether compound.

11. The coating composition of claim 8 wherein the silane compound comprises about 1 to 20% by weight of an amine functional silane.

12. The coating composition of claim 8 wherein the silane compound comprises about 1 to 20% by weight of an alkyl functional silane.

13. The coating composition of claim 8 wherein the silane compound comprises about 0.01 to 10% by weight of a phenyl functional silane.

14. The coating composition of claim 8 wherein the hydroxyl functional compound is glycerin.

15. The coating composition of claim 8 wherein the coating composition further comprises a vinyl acrylic copolymer.

16. The coating composition of claim 8 wherein the coating composition can be diluted with water to form a dilute coating composition with at least 90% by weight water.

17. A concentrated, hydrophilic, hard surface coating composition comprising:
(a) 3 to 55% by weight of a carboxyl functional copolymer,
(b) 8 to 80% by weight of glycerin, (c) 8 to 30% by weight of an amine functional silane; and
(d) the balance water.

18. The coating composition of claim 1 wherein the coating composition can be diluted with water to form a dilute coating composition with at least 90% by weight water.

19. The coating composition of claim 14 wherein the carboxyl functional copolymer is a vinyl acrylic copolymer.

20. The coating composition of claim 17 wherein the coating composition further comprises hydrophilic nanoparticles selected from the group consisting of:
colloidal silica, layers silicates, montomorillonite and titanium dioxide.
